(19) United States
(12) Patent Application Publication
(10) Pub. No.: US 2025/0021919 A1
(43) Pub. Date: Jan. 16, 2025

(54) ENTERPRISE KNOWLEDGE RETENTION AND ACCESS SYSTEM

(71) Applicant: Jelled, Inc., Sunnyvale, CA (US)

(72) Inventors: Ruslan Belkin, Sunnyvale, CA (US); Lei Pan, San Francisco, CA (US); Yuxi Chen, East Palo Alto, CA (US)

(21) Appl. No.: 18/770,248

(22) Filed: Jul. 11, 2024

Related U.S. Application Data
(60) Provisional application No. 63/526,947, filed on Jul. 14, 2023.

(51) Int. Cl. G06Q 10/067

(52) U.S. Cl. CPC G06Q 10/067

(57) ABSTRACT

An enterprise knowledge retention and access system is disclosed. In various embodiments, data comprising a plurality of content items associated specifically with a user is stored. Generative artificial intelligence techniques are used to generate, based at least in part on the plurality of content items associated specifically with the user, a generated content reflecting information derived from the plurality of content items with respect to a specific subject.

### CROSS REFERENCE TO OTHER APPLICATIONS

This application claims priority to U.S. Provisional Patent Application No. 63/526,947 entitled ENTERPRISE KNOWLEDGE RETENTION AND ACCESS SYSTEM filed Jul. 14, 2023 which is incorporated herein by reference for all purposes.

### BACKGROUND OF THE INVENTION

The most effective way to obtain information within an organization may be to ask the right person the right question (i.e., expertise or “know how”). However, there are real-world problems that may impede these human-to-human interactions. For example, the person may not be immediately available (on vacation, out to lunch, etc.). In addition, people have limited short term memory and other human limitations and, as a result, their answers may be limited by the information they have readily accessible at their fingertips and/or at the moment they are asked. People may respond in a manner that is unprofessional or otherwise not aligned with company objectives (e.g., inappropriately disclosing personal or company proprietary information). people may respond in a manner that is inconsistent with facts known to them—they might lie, or misremember, or withhold all or part of the information known to them. Or the right expert may have left the company

### BRIEF DESCRIPTION OF THE DRA WINGS

Various embodiments of the invention are disclosed in the following detailed description and the accompanying drawings.

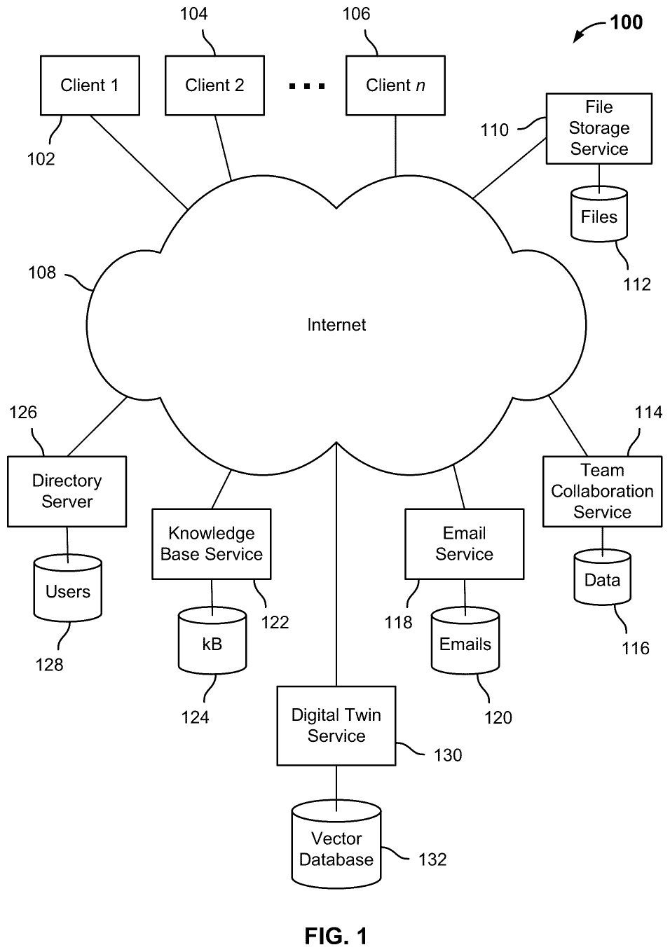

FIG. 1 is a block diagram illustrating an embodiment of an enterprise knowledge and retention system.

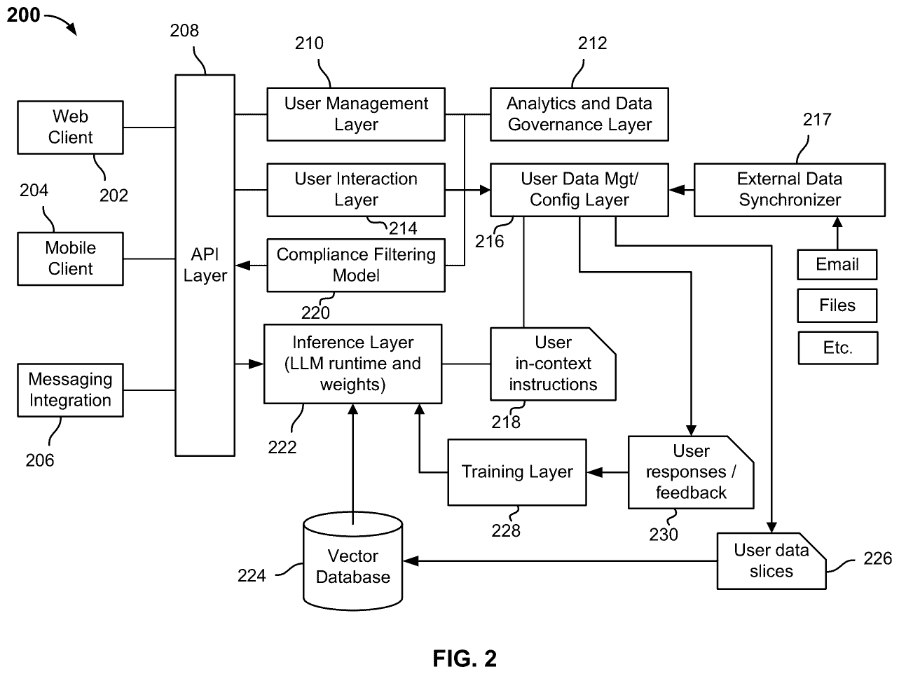

FIG. 2 is a block diagram illustrating an embodiment of an enterprise knowledge and retention system.

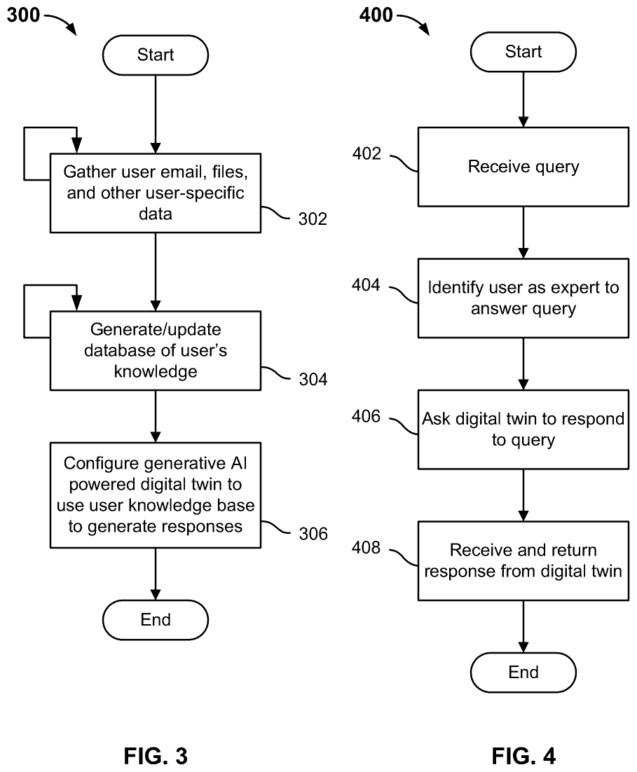

FIG. 3 is a flow diagram illustrating an embodiment of a process to provide a digital twin service.

FIG. 4 is a flow diagram illustrating an embodiment of a process to respond to a query using a digital twin service.

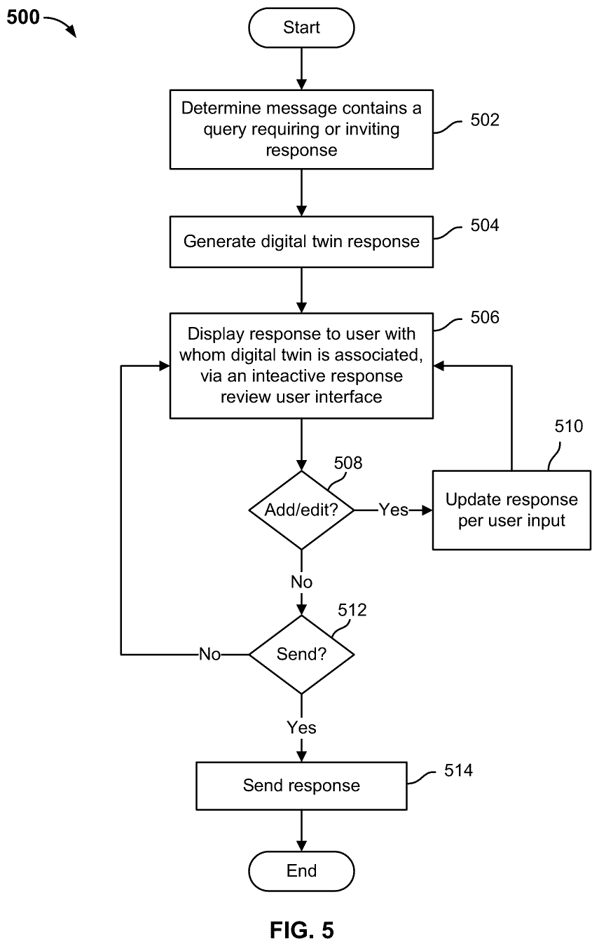

FIG. 5 is a flow diagram illustrating an embodiment of an interactive process to provide a response to a query using a digital twin service.

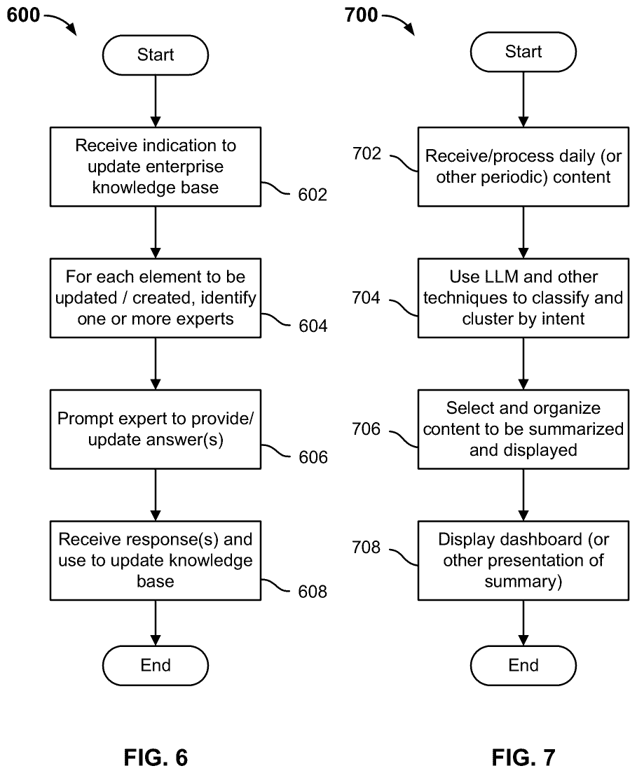

FIG. 6 is a flow diagram illustrating an embodiment of a process to use a digital twin service to maintain an enterprise knowledge base.

FIG. 7 is a flow diagram illustrating an embodiment of a process to use a digital twin service to provide a summary of a communication or other data feed.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques are disclosed to create, maintain, and use Artificial Intelligence (AI)-based digital twins of company employees. Artificial Intelligence in this context includes, without limitation, the use of large language models (LLMs) and other machine learning techniques to mimic human interaction behavior. In various embodiments, such interactions may be mimicked in the enterprise context in a manner that is consistent with company policies and codes of conduct.

In various embodiments, AI entities as disclosed herein, sometimes referred to herein as “AI-based digital twins” or simply “digital twins”, replicate the knowledge, skills, and work behavior of their human counterparts, allowing for anytime access to the employee's expertise, even after they leave the company. Features for data governance, privacy controls, and employee performance analytics are included, in various embodiments.

With the move of most data into the cloud over the last 20 years—practically all relevant data are now readily accessible for analysis, including email, documents, computer source code, customer notes, financial records, etc. In various embodiments, one or more such data sources may be used to generate an AI-based digital twin. For example, a given employee's emails, texts, files, and other data may be used to train a model that can be used to provide an AI-based digital twin capable of generating and providing responses that reflect the knowledge and/or expertise of the given employee (or another person) the AI-based digital twin is configured to mimic.

More recently, advances in machine learning enabled by large language models (LLMs) trained on very large public datasets enabled creation of AI systems capable of efficient data retrieval and human-like reasoning. Available enterprise data is combined together with reasoning capabilities of LLMs, in various embodiments, to provide an autonomous system that is capable of taking on many tasks currently expected to be performed by humans.

In various embodiments, a system as disclosed herein, when deployed within an organization, e.g., may address one or more of the following problems:
Knowledge Retention: The system preserves the knowledge and expertise of employees, including those who leave the company, ensuring the continuity of their contributions.
Productivity: Digital twins handle routine queries and tasks, freeing up human employees to focus on higher-value work.
24/7 Availability: The digital twins are available around the clock, providing answers and assistance even when the human counterparts are not available.
Training and Onboarding: New employees learn from and interact with these digital twins to get up to speed more quickly.
Data-Driven Decisions: The data generated through interactions with AI digital twins as disclosed herein provide valuable insights into employee performance and productivity.
Privacy, Confidentiality, and Compliance: the system contains a mechanism to prevent inappropriate responses from employees that are not aligned with defined company policies.

FIG. 1 is a block diagram illustrating an embodiment of an enterprise knowledge and retention system. In the example shown, system 100 includes a plurality of client devices, represented in FIG. 1 by clients 102, 104, and 106. The clients 102, 104, 106 are connected via the Internet 108 and/or one or more private or public networks to a plurality of cloud based and/or on premises services, represented in FIG. 1 by file storage service 110 configured to store files 112; team collaboration service 114 having associated collaboration data 116; and email service 118 having associated stored emails 120.

The clients 102, 104, 106 also are connected via network 108 with a knowledge base service 122, which provides access to information in an enterprise (or other) knowledge base 124, such as Frequently Asked Questions (FAQ) and corresponding answers, knowledge base articles, automated or human experts, etc.

In various embodiments, directory service 126 manages and provides secure access to stored user identity data and associated user account and access privilege information 128. For example, directory service 126 may store for each user in an enterprise a corresponding set of identity, account, and access privilege information usable by a system as disclosed herein to determine the identity, role(s), group(s), accounts, and services and access such services to extract information usable to provide an enterprise knowledge and retention system as disclosed herein.

In various embodiments, digital twin service 130 uses directory information from directory service 126 to access cloud based, on premises, and/or other services used by a given user, e.g., services 110, 114, 118, to extract and process data associated with the user and to store such information in vector database 132 in a manner that enables the data and its relationship to the user and what the user knows to be retrieved quickly and efficiently.

In various embodiments, digital twin service 132 may be configured to use information about a given user and what the user knows to be used to provide a digital twin service with respect to the user. For example, a query directed to the user, e.g., explicitly addressed to the user or mapped to the user based on a nexus between a subject matter of the query and what the user knows about, may be processed by digital twin service 130 to generate programmatically a response from a “digital twin” of the user. The subject matter of the query may be determined programmatically, e.g., by using a large language model (LLM) or other artificial intelligence techniques to determine an “intent” of a communication that embodies the query, such as an email or a message or post sent via Slack™ or other collaboration and/or communication service.

Data reflecting what the user knows about the subject matter of the query may be extracted from vector database 132 and generative or other artificial intelligence technologies may be used to determine a best answer to the query and to construct a response (or draft response) to the query. In some embodiments, generative AI techniques are used to generate the response based on knowledge of the user, as reflected in data retrieved from vector database 132, and expressed using language, tone, and other content (e.g., graphics) that reflect a style, voice, etc. that the system 100 has learned and/or configured to associate with the user for whom the digital twin response is being generated.

In some embodiments, a response based on the knowledge of a user and/or expressed in a voice, etc. associated with a user may be generated at least in part using retrieval augmented generation (RAG) and/or similar techniques. For example, a body of content associated with the responding user may be searched to find and include in the query as enhanced context data of the user that is or may be relevant to the query. The query plus enhanced context may then be used to query an LLM, via an LLM endpoint. In some embodiments, an LLM that has been fine-tuned using a body of content associated with the responding user, e.g., emails or other communications the user has received and/or sent, may be used.

In some embodiments, digital twin service 130 may be configured to ingest emails and other communications received by a user and use generative AI techniques to generate and provide to the user a summary of the content determined to be most relevant to the user. For example, the user may have indicated preferences via settings or other configuration data and/or the system may have learned over time by observing the user's interaction with previous sets of communications which communications the user interacts with first, etc. and what the user does with or based on each communication.

In some embodiments, digital twin service 130 provides a digital twin of the knowledge base service 122. The digital twin of knowledge base service 122 may determine content that is missing or outdated in knowledge base 124. For example, articles last updated more than a prescribed amount of time ago may be flagged for update. Or user searches of knowledge base 124 that failed to return articles or returned only articles deemed by the requesting user to not be helpful may be identified for review. In various embodiments, data generated and/or managed by digital twin service 130 may be used to identify a user in the enterprise who has the expertise required to update/augment the knowledge base 124 in the relevant respect. The digital twin of the knowledge base may then send a communication to that user prompting the user to provide the information required to update the knowledge base 124.

FIG. 2 is a block diagram illustrating an embodiment of an enterprise knowledge and retention system. In various embodiments, all or some of the modules and components comprising system 200 of FIG. 2 may be provided as modules running on one or more servers comprising digital twin service 130 of FIG. 1. In the example shown, a variety of clients, represented in FIG. 2 by web client 202, mobile client 204, and messaging integration 206, access the enterprise knowledge and retention system of FIG. 2 via an Application Programming Interface (API) layer 208. Web client 202 may comprise a typical browser (e.g., Google Chrome) users use to access the system 200. Mobile client 204 may be an iOS or Android mobile application developed for users to access system 200. Messaging integration 206 may be one of a set of integrations into 3rd party platforms, such as Slack™ and Microsoft™ Teams™, giving users on those platforms the ability to access system 200 from within a context of such platforms. API layer 208 may comprise a REST API layer that governs programmatic access to system 200 by the applications and which ensures proper system security and access (for example, checks for user permissions).

In the example shown, system 200 further includes the following:
User Management Layer 210—a component of the system that allows administrators to add/remove and otherwise manage users, their permissions, teams and access to data and capabilities
Analytics and Data Governance Layer 212—a part of the system that monitors usage, provides analytics data across the system and houses access to company policies and compliance documents
User Interaction Layer 214—a business logic component of the system that governs user interaction flows (i.e. messages, conversations, responses, etc.)
User Data Management and Configuration Layer 216—manages user private connections 217 to data sources (such as email, google drive, etc.), houses user-created documents as part of the data set, houses in-context instructions 218 to the model as well as other configuration with respect to user digital twin
Compliance filtering layer 220—houses a model responsible for filtering out of compliance responses from digital twins, e.g., based on a corporate or user specified communication policy
Inference layer 222 houses the main model (LLM) along with its components (such as swappable task specific layers)
Vector Database 224—houses vector representation of user data 226 along with metadata necessary to retrieve context for the model and for the user
Training layer 228—is an offline system that is used to continuously finetune the model based on user responses and/or feedback 230

In various embodiments, a system as disclosed herein includes one or more of the following:
1. An online server that could be deployed either in the public or private (where so requested by the customer) cloud that performs one or more of the following functions:
   a. Provides an API layer needed for end user applications to interact with the system
   b. Supports functions necessary for the end-user applications to authenticate into the system to make sure the user belongs to the company with the appropriate credentials
   c. Supports functions necessary for new user registration, creation of a collaborative workspace, search and discovery of other users and their active digital twins
   d. Supports user customization functions—such as uploading user profile picture, links and additional information about the user (such as expertise, experience and interests) in the professional context
   e. Supports functions necessary for users to manage data connections to systems users have access to (email, remote drives—such as Dropbox™ and Google Drive™, other systems of collaboration, such as Slack™, Salesforce™, Jira™, Github™, etc) to be able to extract data
   f. Data management layer segregated for each user that manages datasets available to the inference layer
   g. Inference layer responsible for running machine learning models trained with the appropriate dataset to answer questions
   h. User interaction layer that records user dialogs with digital twins, allows the users to correct and modify the answers and store these data to be used for fine tuning and improving the machine learning models. In addition, it allows the user to provide additional instructions (in a natural language) and examples to the system to guide future answers
   i. User feedback layer that allows users to provide feedback on the quality of answers to be used for continuous improvement of the models
   j. Best responses discovery layer runs a machine learning model that uses the entirety of the dataset across all of the digital twins to discover the digital twin that may provide the best answer and informs the user about it (with or without the ability to generate a specific answer, in various embodiments)
   k. Policy compliance layer runs a set of machine learning models against stated company policies and instructions (in a natural language) prior to displaying digital twin answers to the users to assure they are compliant with company policies
   l. Data analytics layer responsible for monitoring system activity and performance
   m. Optional user command layer—where users can configure a limited set of commands (such as “send email to the user X”, “close this customer ticket”) to be executed in defined circumstances by the system itself automatically
2. An end user application through which users interact with the system. The applications may be built using web as well as mobile technologies (such as iOS™ and Android™ OS). The application can also utilize other platforms, such as Slack™.
3. Data extraction layer: a periodically run process that extracts and organizes relevant data from other systems for each user to be used for context creation by the inference layer. Data extraction layer processes domain specific data (e.g., extracts data records from a financial system, ticketing system, source code etc. and converts it into a representation usable by the model). This extraction is strictly governed by each user's specific access permissions and does not require elevated or companywide privileges and therefore by design constraints available dataset only to those normally available to each user in accordance with existing access permissions and policies.
4. Training system: an offline server that monitors and periodically updates model weights based on user-corrected dialogs with digital twins as well as new company specific data provided by system administrators and makes them available to the inference layer.

User Sign Up. In various embodiments, when the user first signs up into the system the user is prompted to connect their datasets (such as email, google drive, slack and other similar systems) into the system. In addition, the user has an option to add additional data, such as documents, to the system. In various embodiments, the end user is in addition presented with an interface to customize one or more of the following:
1. Specify or excuse a list of users the digital twin is allowed to respond to, or alternatively notify the user of an interaction (Example: a user may not want for their digital twin to respond to their supervisor)
2. Specify types of questions to respond and not to respond to
3. Specify a delay of responding to questions and method and urgency of notification to the owner of the digital twin (i.e., email, text message)
4. Outline in plain language response instructions (Example: do not disclose any phone numbers in your answers)

End User Interaction with Digital Twins of Others. In various embodiments, a user can discover available digital twins (including for former users that are no longer with the company) already present in the system (created by other users) and interact with them (either individually or with several—by asking the same question of all of them), e.g., in a natural language via a chat interface.

The user is able to indicate satisfaction with the quality of answers and make suggestions and corrections that will become a part of the training set (if approved by the owner of the appropriate digital twin).

The user may choose to escalate the question-in which case the owner of the digital twin will be notified to take an action and to answer the question that received an unsatisfactory answer from the system or requires a human follow up that cannot be accomplished by the system alone.

End User Interaction with One's Own Digital Twin. In various embodiments, the user is able to see interactions other users are having with his/her digital twin and when required to provide updated (or corrected) answers. These answers will become a part of the training set to improve future performance.

The user can see which questions were unsatisfactorily answered and require attention. The user can review and modify the training set, including reviewing and/or updating data sources that are used to pull data. The user will be able to interact with his/her own digital twin (for example—the user will be able to ask his/her own digital twin something the user believes he knew or likely knew but forgot).

Company administrators. In various embodiments, company administrators can do one or more of the following:
1. Enable/disable certain users to be able to use the system
2. Supply code of conduct (or other) rules (e.g., in plain language) that will be incorporated into the training process and inference process to ensure to the extent possible professional interactions within the company.
3. Perform data search to ascertain specific data that is owned by the company versus data of generic nature and/or private or sensitive data that users may have created to train the digital twin agents.
4. Permit the user to export non-company data for personal use as a personal digital twin.
5. Supply company specific data to train base models used for specific functions (e.g., customer lists, customer interactions from systems of record, HR policies and other global documents, etc.).

Group interactions. In some embodiments, it is possible, e.g., if enabled by systems administrators, to interact with multiple digital twins at once to simulate a human concept of a team meeting or a board meeting—where the same question is asked of multiple digital twins and they are configured to use answers of others for the context to provide further answers. For example, an answer provided by digital twin A may be added to a knowledge/data set of digital twin B, and B's digital twin updated to provide a (further) response to a request, or to answer a subsequent request, based on its knowledge including what it learned from the response by A.

Alternative communication. While the primary communication mechanism may be through the web, in various embodiments described herein, in other embodiments other communication channels and/or technologies may be used, such as a Slack™-type system, a mobile application used by the company, etc. In various embodiments, other channels, such as the email system, may be used to interact with digital twins.

Graceful failure. In some embodiments, when a digital twin is unable to respond to a question (i.e., due to a violation of a business conduct, lack of information, etc.)—the system will notify the user that the question was transmitted to an appropriate human (i.e., when a person has left the company—the question may be sent to a different employee with the same job title, description, credentials, etc., if so configured). Humans in that loop will decide how to respond, in some embodiments.

Model training and improvement. In various embodiments, a system as disclosed herein uses several base large language models (LLMs) trained on large public data sets (i.e., a model like GPT-3). The selection of the base model is determined by the nature of the business of the customer and a different (specialized based model) may be selected. For the purposes of this example, we will use a “generic” base LLM.

As an optional next step, at the request of the customer an additional training step (called fine-tuning) is performed before the activation of the system using customer supplied data (usually unrestricted and normally accessible to all employees), the customer wishes to always incorporate into the knowledge base.

In addition, a model of the system responsible for compliance will be separately trained on the company code of conduct and other materials.

Individual users will be able to configure additional instructions for their specific context (known as in-context learning instructions) to help the model answer the questions.

During system operation and as data accumulates with respect to quality of answers generated by digital twins, additional training steps are automatically taken by the system using various techniques, including HFRL (human feedback reinforcement learning) determined by the size of available feedback data.

FIG. 3 is a flow diagram illustrating an embodiment of a process to provide a digital twin service. In various embodiments, the process 300 of FIG. 3 is performed by one or more servers configured to provide a digital twin service, such as digital twin service 130 of FIG. 1. In the example shown, at 302 user emails, files, and/or other user specific content is gathered for each of one or more users for whom a digital twin is to be provided. At 304, a database reflecting each user's knowledge is updated. For example, an LLM or other techniques may be used to determine for each item of content an intent and/or subject matter content of the item. Each of at least a subset of the items may be stored, e.g., in a vector database such as vector database 132 of FIG. 1, in a manner that associates the item with the user and a specific aspect of the user's knowledge. For example, an item of content that comprises a communication in which a user ABC provides advice about a company (or technology, etc.) XYZ may be stored in a way that facilitates quick/efficient retrieval of the item and other items that reflect what the user ABC knows about XYZ and/or about a specific topic or area of expertise with respect to which ABC offered their opinion with respect to XYZ. At 306, a generative AI-power digital twin is configured to provide, for each of one or more users, a digital twin able to provide responses or other content reflecting what the user knows.

In some embodiments, step 306 may include configuring the digital twin service to use content data reflecting each user's knowledge to perform Retrieval Augmented Generation (RAG) or similar processing with respect to queries sent to the user. In some embodiments, step 306 may include fine tuning an LLM using content data reflecting each user's knowledge to provide for each of at least a subset of the users a user-specific LLM that has been fine-tuned based on that user's content and/or knowledge.

In some embodiments, the user's data stored in steps 302 and 304, which may be repeated as necessary and/or performed continuously, e.g., a further content is created and/or received, may be configured to be used to augment a query directed to the user and/or their digital twin. For example, an LLM or other techniques may be used to determine that a communication to the user comprises a request for information and/or advice of a specific nature with respect to a subject. In various embodiments, the query may be augmented at least in part using Retrieval Augmented Generation (RAG) or similar techniques. For example, if user ABC is asked for information or advice regarding XYZ, continuing the example above, in some embodiments user ABC's data as received and stored in steps 302 and 304 may be retrieved and used to augment the query based on content reflecting what ABC knows about XYZ. The resulting augmented query may be sent to an LLM endpoint, which may be associated with a general purpose LLM or an LLM fine-tuned based on the user's knowledge/content, and the response used to generate and provide a response from the digital twin.

FIG. 4 is a flow diagram illustrating an embodiment of a process to respond to a query using a digital twin service. In various embodiments, the process 400 of FIG. 4 is performed by one or more servers configured to provide a digital twin service, such as digital twin service 130 of FIG. 1. In the example shown, at 402 a query is received. At 404, a user who has the expertise to respond to the query may be determined. In some cases, the query may have been sent to a specific individual. In other cases, a database or other repository of user expertise may be consulted and/or the query may be provided to each of a plurality of digital twins, and the respective responses compared or otherwise assessed to determine an expert to respond to the query. In some embodiments, an LLM or other AI may be used to select the best response.

At 406, the digital twin of the user identified at 404 is asked to respond to the query, if a response has not already been received and/or assessed. For example, the query may be augmented using RAG, as described above. At 408, a response to the query is received and returned. If configured, the response may be sent to the requesting user without prior review by the responding user with whom the responding digital twin is associated. In some embodiments, the responding user may have an opportunity to review and/or revise the response prior to its being sent to the requesting user.

In some embodiments, prior to a response being returned, one or more enterprise policies may be applied to the response. For example, an LLM or other technique may be used to verify that the digital twin generated response complies with all enterprise communication and security requirements and/or applicable regulatory requirements, such as by using proper language, not disclosing enterprise trade secrets, not using offensive or otherwise unprofessional language or tone, etc.

FIG. 5 is a flow diagram illustrating an embodiment of an interactive process to provide a response to a query using a digital twin service. In various embodiments, the process 500 of FIG. 5 is performed by one or more servers configured to provide a digital twin service, such as digital twin service 130 of FIG. 1. In the example shown, at 502 a communication (e.g., email, chat or instant message, post, etc.) is determined to contain a query requiring or inviting a response. For example, an LLM and/or other techniques (regular expression, rule, filter, heuristic, etc.) may be used to determine that a message is from and/or to a specific user and poses an explicit or implied question on a subject. At 504, a response by a digital twin, e.g., of a recipient to whom the communication was addressed, is generated. At 506, the response generated at 504 is displayed to a user with whom the digital twin that generated the response is associated, via an interactive user interface that enables the user to accept, augment (e.g., by adding an attached document), and/or edit prior to send. If an indication is received at 508 to add to or edit the response, then at 510 the response is updated as indicated by the user. Once an indication is received at 512 to send the response, the response is sent at 514 and process 500 ends.

FIG. 6 is a flow diagram illustrating an embodiment of a process to use a digital twin service to maintain an enterprise knowledge base. In various embodiments, the process 600 of FIG. 6 is performed by one or more servers configured to provide a digital twin service, such as digital twin service 130 of FIG. 1, and/or a knowledge base system, component, and/or service, such as knowledge base service 122 of FIG. 1. In the example shown, at 602 an indication is received to update an enterprise knowledge base. For example, an item may be determined to require to be updated based on a date on which the item was last updated. Or a customer or other user of the knowledge base may have posed a question that could not be answered or answered to the satisfaction of the requestor based on content currently in the knowledge base. In some embodiments, the indication received at 602 may be generated by generative AI. For example, a question posed by customer A may be included in a prompt to generate other questions a future customer may pose.

At 604, for each item (e.g., article, FAQ, response, etc.) to be updated and/or created one or more experts on the relevant topic are identified. For example, a directory or other repository of users and each user's expertise may be consulted. Or an LLM may be used to rank, score, or otherwise evaluate responses to queries sent to users' respective digital twins. At 606, the expert(s) identified at step 604 is/are prompted to provide the updated or new information required for the knowledge base. At 608, the response(s) received from the expert(s) are used to update the knowledge base. For example, responses from multiple experts may be merged and summarized using generative AI or other techniques, and the resulting content added to the knowledge base.

In some embodiments, a system as disclosed herein may continuously monitor enterprise communication channels and relevant data sources to create and enrich the enterprise knowledge base. For example, an exchange between employees and/or between an employee and a customer may be observed to reflect a type of query and corresponding response that are not yet reflected in the knowledge base. In response, the knowledge base may be updated automatically and/or the update may be suggested to a user.

Managing an email inbox and responding to messages can be extremely time-consuming. Crafting appropriate responses with relevant contextual information requires extensive data discovery, including locating previously received attachments, historical emails, and other pertinent data sources. Consequently, responses to important emails are often delayed due to the overwhelming volume of communications.

In various embodiments, a system a disclosed herein may perform one or more of the following:
Proactively monitor your email inbox for important messages that require a response.
Analyze email content and attachments to detect intent and filter out spam, sales outreach, and other non-essential categories.
Utilize your historical email behavior to identify email categories, senders, and subjects you typically prioritize and respond to.
Generate draft responses in your inbox that match your communication style.
Integrate contextual information from your knowledge base into your email responses.
Actively manage your inbox by applying relevant labels to organize and prioritize emails.

Email is a critical form of enterprise communication, often acting as both the data pipeline and knowledge repository for employees. However, the low signal-to-noise ratio means that important emails and related actions are not prioritized correctly. Retrieving relevant information from these emails is challenging, and there is a high overhead associated with quantifying and visualizing the data contained within them.

In various embodiments, a system a disclosed herein may perform one or more of the following:
Classify emails based on intent, adhering to user preferences to prioritize categories of interest or concern.
Group important emails into clusters based on detected categories and trends.
Extract metrics from email content and attachments to build historical data points for each cluster.
Visualize these data points in a trends dashboard for quick and easy access.

FIG. 7 is a flow diagram illustrating an embodiment of a process to use a digital twin service to provide a summary of a communication or other data feed. In various embodiments, the process 700 of FIG. 7 is performed by one or more servers configured to provide a digital twin service, such as digital twin service 130 of FIG. 1. In the example shown, at 702 daily (or other periodic) content received by a user is received and processed. At 704, an LLM and/or other techniques are used to classify and cluster by intent, across multiple platforms, a plurality of content items comprising the content, e.g., numerous emails, text messages, chat/instant messages, channel feeds, etc. At 706, content is selected, organized, and summarized to be displayed to the user. For example, clusters may be selected based on a user's explicit expression of interest, e.g., via settings, rules, filters, or other configuration data and/or the system may learn the user's practices and preferences, such as by observing content the user engages with, skims, dismisses, etc. In some embodiments, the user may be provided with controls to train the system explicitly, e.g., to “show more like this” or “don't show me this”, etc. At 708, the selected and summarized content is displayed, e.g., via a dashboard or other display.

In various embodiments, a system as disclosed herein is configured to ingest and correlate data from heterogeneous platforms and in different file formats and having different content, such as spreadsheets, graphs, charts, tables, and images. In various embodiments, semantic information is gleaned from all such sources and forms of content and new representations may be generated of content summaries and/or content extracted from multiple sources. For example, a given row in a table received daily may contain information for which a user may wish to see a trend over time. The system may be configured and/or may learn to extract the row of interest from many instances of the daily table and generate a summary data structure and/or representation (e.g., table, graph, chart, etc.) that shows the trend over time, across daily sample points, as extracted from the daily communications. In various embodiments, such processing and summary/trend generation may be performed based on an explicit question received from the user who received the daily emails, i.e., from their own digital twin, or in response to a query direct to the user from another.

In some embodiments, active directory or other enterprise user information, and other sources such as customer relationship management (CRM) services, may be used by a system as disclosed herein to tailor a response by a digital twin based on who asked the question. For example, the user of a digital twin may respond using somewhat different language, tone, and content, depending on whether the user is a superior or subordinate of the user with whom the digital twin is associated, or has some other relationship such as family member, customer, sales prospect, etc.

In various embodiments, techniques disclosed herein may be used to provide one or more of the following:
1. An AI (artificial intelligence) based system that represents and mimics interactions from a point of view of a specific individual (an employee of the company) using data (currently, previously, etc.) accessible to that employee along with instructions supplied by that employee to the system to guide responses.
2. A system that strictly segregates individual data, such that responses given and actions taken are always from a context and access capabilities of an individual employee represented by the AI digital twin.
3. A system where digital twin responses are checked by the compliance system automatically to prevent responses and actions that are outside of defined code of conduct, even if otherwise possible.
4. A system where digital twin responses not only use the knowledge available to a human user, but also imitates—to the extent compliant with company policies the individual style of language of the user, in order to mimic as close as possible a real human to human interaction with a specific individual.
5. A system used as a mechanism of factual knowledge retention, discovery, and sharing that survives individual employment. For example, the system may be used to interact with doppelgangers of departed employees.

In various embodiments, techniques disclosed herein may be used to provide “anytime access” to the knowledge and expertise of any member associated with an enterprise, include those no longer employed by or otherwise associated with the enterprise. In various embodiments, techniques disclosed herein may be used to improve the efficiency and productivity of any user, e.g., by providing auto-generated responses or draft responses to inquiries and/or summarizing volumes of information, e.g., in the user's email inbox and/or other communication channels and/or data feeds.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a memory configured to store data comprising a plurality of content items associated specifically with a user; and
a processor coupled to the memory and configured to use generative artificial intelligence techniques to generate based at least in part on the plurality of content items associated specifically with the user a generated content reflecting information derived from the plurality of content items with respect to a specific subject.

2. The system of claim 1, wherein the plurality of content items includes a first set of items associated with a first platform, channel, or service and a second set of items associated with a second platform, channel, or service.

3. The system of claim 1, wherein the plurality of content items includes a plurality of communications sent to the user.

4. The system of claim 1, wherein the plurality of content items includes a plurality of files, documents, or other stored objects associated with the user.

5. The system of claim 1, wherein the processor is further configured to store the plurality of content items in the memory.

6. The system of claim 5, wherein the processor is further configured to store the plurality of content items in a manner that associates each item with the user and which associates with the subject a subset of items that relate to the subject.

7. The system of claim 1, wherein the processor is configured to use generative artificial intelligence techniques to generate the generated content at least in part by using at least a subset the plurality of content items associated specifically with the user to perform retrieval augmented generation with respect to a query in response to which the generate content was generated.

8. The system of claim 1, wherein the processor is configured to use generative artificial intelligence techniques to generate the generated content at least in part by using at least a subset the plurality of content items associated specifically with the user to fine tune a large language model (LLM) used to generate the generated content.

9. The system of claim 1, wherein the generated content comprises a summary of at least a subset of the plurality of content items.

10. The system of claim 9, wherein the summary is displayed to the user in the form of a dashboard or other summary display.

11. The system of claim 1, wherein the generated content is generated in response to a query from a requesting party other than the user.

12. The system of claim 11, wherein the generated content is displayed to the user prior, to being sent to the requesting party, via an interactive user interface that enables the user to modify the generated content prior to its being sent to the requesting party.

13. The system of claim 1, wherein the generated content is generated in response to receipt of an indication of a need to update an enterprise knowledge base with respect to the specific subject.

14. The system of claim 1, wherein the processor is further configured to apply a policy to the generated content.

15. The system of claim 1, wherein the processor is configured to generate the generated content based at least in part on an indication that the user is not available to provide the content.

16. The system of claim 15, wherein the unavailability of the user may be due to one or more of time of day, vacation or other absence, the user no longer being employed by an enterprise with which the system is associated, and the user being deceased.

17. The system of claim 1, wherein the processor is further configured to identify the user as an expert with respect to the specific subject.

18. The system of claim 1, wherein the processor is configured to identify the user as an expert with respect to the specific subject at least in part by sending a query to each of a plurality of digital twins, each configured to use generative artificial intelligence and a user-specific set of content data to generate a response on behalf of a different user, include the user; receive from each digital twin a corresponding response; and use a large language model to determine based at least in part on the responses that the user is an expert with respect to the specific subject.

19. A method, comprising:
storing data comprising a plurality of content items associated specifically with a user;
using generative artificial intelligence techniques to generate, based at least in part on the plurality of content items associated specifically with the user, a generated content reflecting information derived from the plurality of content items with respect to a specific subject.

20. A computer program product embodied in a non-transitory computer readable medium and comprising computer instructions for:
storing data comprising a plurality of content items associated specifically with a user;
using generative artificial intelligence techniques to generate, based at least in part on the plurality of content items associated specifically with the user, a generated content reflecting information derived from the plurality of content items with respect to a specific subject.
